(19) United States
(12) Patent Application Publication
(10) Pub. No.: US 2022/0130036 A1
(43) Pub. Date: Apr. 28, 2022

(54) INFORMATION PROCESSING APPARATUS, ELECTRONIC DEVICE AND METHOD

(71) Applicant: Sony Group Corporation, Tokyo (JP)

(72) Inventors: Alexander GATTO, Stuttgart (DE); Ralf MUELLER, Stuttgart (DE); Hironori MORI, Stuttgart (DE); Piergiorgio SARTOR, Stuttgart (DE)

(73) Assignee: Sony Group Corporation, Tokyo (JP)

(21) Appl. No.: 17/422,758

(22) PCT Filed: Jan. 21, 2020
(86) PCT No.: PCT/EP2020/051399

§ 371 Date: Jul. 14, 2021

(30) Foreign Application Priority Data
Jan. 21, 2019 (EP) 19152755.5

(51) Int. Cl. G06T 7/00; G06T 7/70; G06V 20/10; G06V 20/68

(52) U.S. Cl. CPC G06T 7/0012; G06T 7/70; G06V 20/188; G06T 2207/30188; G06T 2200/24; G06T 2207/10036; G06V 20/68

(57) ABSTRACT

An information processing apparatus having circuitry which performs object recognition on image data in order to recognize individual fruits and determines a harvest point of time for each recognized individual fruit.

### TECHNICAL FIELD

The present disclosure generally pertains to fruit harvesting and in particular to an information processing apparatus, an electronic device and a method suitable for determining a harvest point of time for a fruit.

### TECHNICAL BACKGROUND

Generally, it is known to grow fruits, such as tomatoes, strawberries, apples, etc., in a professional environment (e.g. agriculture, greenhouse, etc.) or even at home (e.g. in a garden, balcony, terrace, etc.), wherein, typically, a suitable point of time for harvesting the fruit may be important. However, the determination of a suitable point of time for harvesting may not be easy in some occasions, and, for example, may depend on a personal experience of a user, weather or other environmental conditions, etc.

Moreover, it is generally known to determine a degree of ripeness of fruits, for example, based on a spectral image of the fruit.

However, it is generally desirable to provide an information processing apparatus, an electronic device and a method, in particular, for determining a harvest point of time for a fruit.

### SUMMARY

According to a first aspect, the present disclosure provides an information processing apparatus, comprising a circuitry configured to perform object recognition for recognizing an individual fruit based on image data and to determine a harvest point of time for the recognized individual fruit.

According to a second aspect, the present disclosure provides an electronic device comprising an information processing apparatus, comprising a circuitry configured to perform object recognition for recognizing an individual fruit based on image data and to determine a harvest point of time for the recognized individual fruit.

According to a third aspect, the present disclosure provides a method, comprising performing object recognition for recognizing an individual fruit based on image data and for determining a harvest point of time for the recognized individual fruit.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 shows an embodiment of an information processing apparatus;

FIG. 2 illustrates a block diagram the setup of the information processing apparatus of FIG. 1;

FIG. 3 illustrates a flow chart of an embodiment of a method for recognizing a fruit, which may be performed by the information processing apparatus of FIG. 1;

FIG. 4 illustrates a flow chart of an embodiment of a method for estimating a degree of ripeness, which may be performed by the information processing apparatus of FIG. 1;

FIG. 5 illustrates a flow chart of an embodiment of a method for determining a harvest point of time of the fruit of FIG. 3, which may be performed by the information processing apparatus of FIG. 1;

FIG. 6 illustrates a flow chart of an embodiment of a method for determining at least one environmental condition, which may be performed by the information processing apparatus of FIG. 1;

FIG. 7 depicts an embodiment of a graphical user interface assisting a user harvesting a fruit;

FIG. 8 depicts an embodiment of a graphical user interface indicating a coarse position of a recognized individual fruit;

FIG. 9 illustrates a flow chart of an embodiment of a method, which may be performed by the information processing apparatus of FIG. 1;

FIG. 10 is a further illustration of the information processing apparatus of FIG. 1; and

FIG. 11 shows an embodiment of a system for a harvest robot for harvesting fruits.

### DETAILED DESCRIPTION OF EMBODIMENTS

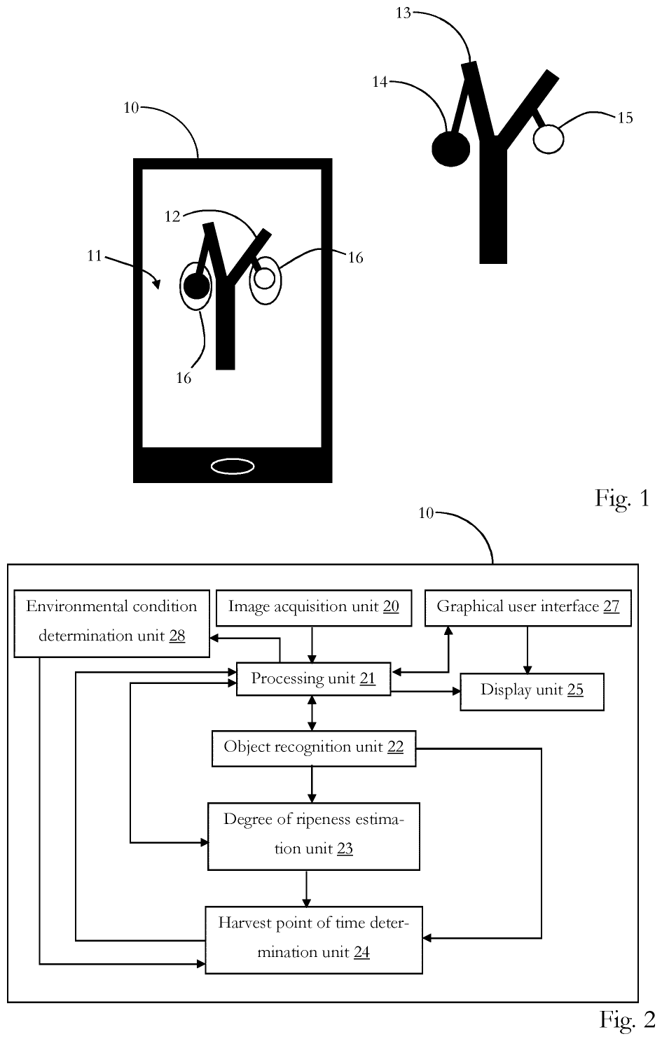

Before a detailed description of the embodiments under reference of FIG. 1 is given, general explanations are made.

As mentioned in the outset, the determination of a suitable point of time for harvesting of a fruit may not be easy in some occasions, and, for example, may depend on a personal experience of a user, weather or other environmental conditions, etc.

Hence, some embodiments pertain to an information processing apparatus, including circuitry configured to perform object recognition for recognizing an individual fruit based on image data; and determine a harvest point of time for the recognized individual fruit.

The information processing apparatus may be a wearable device, e.g. a smart glass, smart watch, smart band, etc., it may be a device which can be worn in the hand of a user, such as a smartphone, mobile phone, tablet computer, tablet device, digital (still/video) camera, or the like, a personal computer, or any other type of electronic device.

The circuitry may include one or more electronic components, which are typical for the information processing apparatus, such as one or more (micro-)processors, logic processors, memory (e.g. read-only and/or random access memory), storage device (e.g. hard-disk, compact disk, flash drive, solid-state drive, etc.), display (e.g. liquid-crystal display, organic light emitting display, light-emitting diode based display, etc.), image sensor (e.g., based on complementary-metal oxide semiconductor technology, charged coupled device technology, etc.), etc. In some embodiments, the circuitry also includes special components which are tailored to characteristics or features which are discussed herein, e.g. for object recognition, multi-spectral imaging, etc.

As mentioned, the circuitry is configured to perform object recognition, such that in some embodiments, the circuitry itself is able to perform the object recognition, wherein in other embodiments the circuitry may perform object recognition by instructing or using another device accordingly, which may be part of the information processing apparatus or not. Hence, in some embodiments, image data, which may be obtained by the information processing apparatus, may be transmitted to another device over an interface (e.g. universal serial bus, firewire, local area network, wireless network, Bluetooth, infrared, internet, etc.) to the other device for performing the object recognition based on the image data.

The image data itself may be representative of the individual fruit and may be obtained by imaging the individual fruit (or imaging a larger area in which the individual fruit is located). The image data may be raw data, compressed image data (jpeg, gif or the like), etc. may be included in a data file, provided via a bit stream, etc. The image data may be obtained with an imaging sensor included in the information processing apparatus, or connected to the information processing apparatus, or it may also be obtained via an interface (e.g. universal serial bus, firewire, local area network, wireless network, Bluetooth, infrared, internet, etc.).

The individual fruit may be any kind of fruit, such as apple, pear, strawberry, grape, tomato, pea, zucchini, etc., wherein the individual fruit may be located adjacent to other fruits on a tree, bush, shrub, etc. Hence, in some embodiments, a specific individual fruit is recognized among multiple fruits based on the image data.

Generally, algorithms for performing object recognition are known and it may be based on machine learning based methods or explicit feature based methods, such as shape matching, for example by edge detection, histogram based methods, template match based methods, color match based methods, or the like. In some embodiments, a machine learning algorithm may be used for performing object recognition, which may be based on at least one of: Scale Invariant Feature Transfer (SIFT), Gray Level Co-occurrence Matrix (GLCM), Gabor Features, Tubeness, or the like. Moreover, the machine learning algorithm may be based on a classifier technique and the image data may be analyzed, wherein such a machine learning algorithm may be based on least one of: Random Forest; Support Vector Machine; Neural Net, Bayes Net, or the like. Furthermore, the machine learning algorithm may apply deep-learning techniques and the image data may be analyzed, wherein such deep-learning techniques may be based on at least one of: Autoencoders, Generative Adversarial Network, weakly supervised learning, boot-strapping, or the like.

Generally, models for determining optimum harvest windows, which may be used for determining a harvest point of time for the recognized individual fruit, are known, and, thus, a detailed description of such models is omitted. In some embodiments, such models may be based on a measurement of reflectance spectra of light reflected by a fruit and applying a partial least squares regression or a multiple linear regression to the measured reflectance spectra. In some embodiments, global calibration models, Streif index, De Jager Index, FARS index, biospeckle method, or the like are used alone or in combination for determining the harvest point of time for the recognized individual fruit.

Furthermore, the model may be selected on the basis of the kind of fruit. For example, a tomato may have a different mechanism of ripening than an apple, or the like, as is generally known.

The harvest point of time may be a discrete point of time or a time interval, it may be a date or it may also be a time distance (e.g. in three days or the like) in which the individual fruit may be harvested. Moreover, the harvest point of time may be a point of time (including a time window, etc., as discussed) in which the recognized individual fruit may have a predefined degree of ripeness. The predefined degree of ripeness may be a state of ripeness at which the fruit has an optimal state of ripeness for eating or it may also be a state of ripeness at which the fruit has not yet reached the optimal state of ripeness, such that ripeness may further develop after being harvested (e.g. during transport, storage, etc.).

In some embodiments, the circuitry is further configured to estimate a degree of ripeness of the recognized individual fruit, wherein the harvest point of time is determined based on the estimated degree of ripeness of the recognized individual fruit.

The degree of ripeness may be indicative of a percentage referring to how much time the recognized individual fruit still has to ripe compared to the total time of ripening before it may be harvested.

The degree of ripeness may further (also) be indicative of a color and appearance of the fruit, the concentration of biochemicals such as chlorophyll, carotenoids, polyphenols, or the like. These parameters may be measured estimated based on colorimetric methods, visible imaging, visible spectroscopy, infrared spectroscopy, fluorescence sensors, spectral imaging, such as hyperspectral imaging or multispectral imaging, or the like.

On the basis of such measurements (one or more of them), the degree of ripeness may be estimated, since, for example, corresponding data is known for each kind of fruit and associated degrees of ripeness, such that by comparing corresponding measurement results with the known data, the degree of ripeness can be estimated.

The degree of ripeness may be estimated based on the image data which is also used for recognizing the individual fruit and/or it may be based on additional image (spectral data) or the like.

In order to estimate the degree of ripeness spectral data may be set into relation, i.e. by determining a ratio between the transmission values at different wavelengths, calculating the normalized difference vegetation index, calculating the red-edge vegetation stress index, or the like. The degree of ripeness may further be estimated based on applying the partial least squares model, principal component analysis, multiple linear regression, or the like to selected wavelengths.

The harvest point of time may be determined using the estimated degree of ripeness of the recognized individual fruit (i.e. the current status of the degree of ripeness at the point of time of estimation) as a starting point for the model which is used according to the description above for determining a future degree of ripeness at which the recognized individual fruit should be harvested.

The degree of ripeness may be estimated based on multispectral image data, and, e.g. based on using an artificial neural network model, quadratic discriminant analysis, discriminant analysis, or the like, which trained accordingly to the estimated the degree of ripeness on the basis of the multispectral image data.

The multispectral image data may be used together with the image data for estimating the degree of ripeness of the recognized individual fruit.

In some embodiments, multispectral imaging may be used for obtaining the multispectral image data in order to estimate the degree of ripeness. The multispectral image data may be obtained using a liquid crystal tunable filter, charged coupled device sensors, complementary metal oxide semiconductor sensors, bandpass filters, etc.

The multispectral imaging may be performed with the or an additional imaging sensor of the information processing apparatus.

In some embodiments, performing the object recognition includes determining a kind of fruit for the recognized individual fruit.

In some embodiments, the determination of the harvest point of time for the recognized individual fruit is based on the kind of fruit.

In some embodiments, the determination of the harvest point of time is based on at least one environmental condition.

The ripening process of the (recognized individual) fruit may depend on environmental conditions, which may include or being indicated by meteorological information, geographical position, illumination conditions and architectural information or the like. Therefore, the process of ripening of the recognized individual fruit is influenced by the environmental conditions, such that a future degree of ripeness of the recognized individual fruit also depends on the environmental conditions and, thus, the harvest point of time may also depend on the environmental conditions.

The meteorological information may include air humidity, air temperature, air pressure, air density, wind velocity, ozone values, cloudiness or precipitation information or the like.

The geographical position may include may include global positioning coordinates or height information or the like.

The illumination conditions may include sunshine duration, light intensity, illumination duration or light spectrum or the like. The illumination conditions may further be indicative of a kind of light source, if the plant is in proximity to an artificial light source or placed inside or the like. It may also be indicative of shadows casted on the plant, if the plant is placed outside or in proximity to a window, the sunlight intensity or the sunshine duration irradiated on the plant or the like.

The architectural information may include information about shadows or whether the fruit is located inside or outside a building, it may be indicative of structures which obstruct the sunlight incident on the fruit, etc.

In some embodiments, the information processing apparatus determines the position of the recognized individual fruit, such that, for example, a user is able to find a recognized individual fruit among a plurality of fruits, for example in a garden.

Determining the position may include determining the geographical position of the fruit in order to distinguish at which plant among a plurality of plants the recognized individual fruit may be found. The geographical position may be determined by global positioning data, for example.

Determining the position may also include determining whether the plant is placed inside or outside of a room with the help of image data, if the plant is placed inside a room, at which position of the room the plant is placed, for example, whether the plant is placed in proximity to a window. The position may further include, if the plant is placed outside a room, whether the plant is placed in proximity to a wall.

The position of the recognized individual fruit within the plant may further be determined by object recognition, for example with the SLAM method (Simultaneous Localization and Mapping) in devices having an inertial measurement unit, or the like.

The position of the recognized individual fruit may also be a relative position, e.g. next to a structural part of the plant on which the fruit is located, to other fruits, which have been recognized, etc.

In some embodiments, the circuitry is further configured to provide a graphical user interface for guiding a user to the recognized individual fruit, wherein, for example, the graphical user interface may be displayed on a display (e.g. of the information processing apparatus).

The graphical user interface may include a map (or other graphical elements, e.g. arrows, graphical elements indicating a direction, way to go, position of fruit, etc.) for guiding the user to an individual fruit. If no fruit can be recognized, the graphical user interface may guide or assist a user to acquire image data or multispectral image data of a fruit, e.g. by giving hints (graphical, audio, visual) to the user causing him to direct, for example, a camera (or multispectral camera) in a correct direction for acquisition of image data of a fruit.

The graphical user interface may include a text which may indicate whether the recognized individual fruit can be harvested.

The text may also indicate that the user needs to take actions in order for the object recognition to be performed, the determination process to be performed or the degree of ripeness estimation process to be performed.

The graphical user interface may provide information to the user that causes the user to perform an action, e.g. moving an image acquisition unit (image sensor) to another position for obtaining image date being useful for the object recognition of an individual fruit.

The graphical user interface may also provide information to the user that causes the user to perform an action to obtain or take further image data at another point of time in the case that the harvest point of time cannot be determined or can only be determined with a high uncertainty (e.g. above a predefined certainty threshold), e.g. since the degree of ripeness of the recognized individual fruit can only be estimated with a high uncertainty. For instance, if the harvest point of time for the recognized individual fruit is far in the future (e.g. weeks), then the uncertainty about the degree of ripeness will be high due (e.g. since also the weather conditions cannot be predicted accurately for such large time scales, the prediction of the process of ripening will have higher uncertainties on large times scales, etc.).

The graphical user interface may also provide information to the user that causes the user to perform an action to change the illumination conditions such as turning on the light, acquire additional multispectral image data, acquire image data from another position, or the like, in order to improve the accuracy for the estimation of the degree of ripeness of the recognized individual fruit.

Further, the graphical user interface may be configured to indicate a position of the recognized individual fruit.

The position of the recognized individual fruit may be a coarse position of the fruit which corresponds to the position of the corresponding plant at which the fruit is located. The coarse position of the plant may be determined using GPS data or other global positioning information. The position of the corresponding plant may also be determined by recognizing, e.g. with object recognition, the plant from a plurality of plants.

The position of the recognized individual fruit may further include the exact position of the fruit within the corresponding plant at which the fruit is located.

The graphical user interface may further provide information about the estimated degree of ripeness or the harvest point of time of individual fruits. If the harvest point of time cannot be determined or is too far in the future, the graphical user interface may provide a second check date to the user. The second check date is a point of time at which the user needs to acquire more image data of the individual fruit.

This may also be the case when the degree of ripeness is below a predetermined threshold value, some or all of the environmental data are not determinable or too uncertain, or the like.

The information about the estimated degree of ripeness or the harvest point of time may further be used for setting an alarm or may be indicative of an alarm for notifying the user at the second check date or the harvest point of time, or providing a harvest schedule.

The graphical user interface may further provide information about how to influence the harvest point of time. For example, it may be suggested that the position or posture of the plant should be changed. It may also be suggested that the plant should be watered. However, the suggestions are not limited to the described ones. For example, if the user will be away for a certain amount of time and is therefore not able to check or harvest the fruits, information is provided on how to receive an optimal harvest yield. For example, it may be suggested that a subset of the fruits is collected immediately.

The suggestions may be based on an estimation of a risk of over-ripening of the fruits and the search of alternatives for influencing the ripening, or the like.

Some embodiments pertain to a method, including performing object recognition for recognizing an individual fruit based on image data; and determine a harvest point of time for the recognized individual fruit, as discussed above.

The method may be performed on an information processing apparatus as described above or by any other apparatus, device, processor, circuitry or the like. The method may further comprise estimating a degree of ripeness of the recognized individual fruit, wherein the harvest point of time is determined based on the estimated degree of ripeness of the recognized individual fruit, as discussed herein, wherein the estimation of the degree of ripeness of the recognized individual fruit might be based on multispectral image data. The performing of the object recognition may include determining a kind of fruit for the recognized individual fruit, as discussed herein. The determination of the harvest point of time for the recognized individual fruit may be based on the kind of fruit, as discussed herein. The determination of the harvest point of time may be based on at least one environmental condition, as discussed herein, wherein the at least one environmental condition may include at least one of: meteorological information, geographical position, illumination conditions and architectural information. The object recognition may include determining a position of the recognized individual fruit, as discussed herein. The method may further comprise providing a graphical user interface for guiding a user to the recognized individual fruit, as discussed herein and/or it may further comprise providing a graphical user interface for guiding a user to acquire at least one of the image data and multispectral image data of the recognized individual fruit.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 1, an embodiment of the information processing apparatus 10 is illustrated, wherein in this embodiment, the information processing apparatus 10 is a mobile phone. The information processing apparatus has a display unit 11 at which for explanation purposes an image 12 of a plant 13 is displayed, wherein the image 12 is taken with a camera of the mobile phone 10. The plant 13 has a ripe fruit 14 and an unripe fruit 15.

The mobile phone 10 has an object recognition unit (not illustrated), which performs an objection recognition for recognizing individual fruits, such as fruits 14 and 15 of the plant 13.

A graphical user interface of the mobile phone 10 superimposes, on the displayed image, the recognized individual fruits with graphics 16 to visualize that the individual fruits are recognized.

FIG. 2 illustrates block diagram of the mobile phone 10. The mobile phone 10 has and image acquisition unit 20, a processing unit 21, an object recognition unit 22, a degree of ripeness estimation unit 23, a harvest point of time determination unit 24, a display unit 25, a graphical user interface 27, and an environmental condition determination unit 28.

The image acquisition unit 20 is a multispectral camera and it acquires an image and transmits the image data to the processing unit 21.

The processing unit 21 is a central processing unit (CPU), and it processes the image data acquired by the image acquisition unit 20 and transmits them to the display unit 25, the object recognition unit 22, the degree of ripeness estimation unit 23, the graphical user interface 27, and the environmental condition determination unit 28.

The processing unit 21 receives data from the object recognition unit 22, indicating whether the object recognition process was successful (or not). If the object recognition process was successful, data concerning the recognized individual fruits are received. The data concerning the recognized individual fruits (indirectly) include the position of each recognized fruit and the kind of each recognized fruit, since the data are indicative of the position of each recognized fruit.

Further, the processing unit 21 receives data from the degree of ripeness estimation unit 23 concerning the degree of ripeness of the recognized individual fruits.

Further, the processing unit 21 receives data from the harvest point of time determination unit 24, which are indicative of a harvest point of time (when it has been determined) and it may optionally receive data indicating that the harvest point of time could not be determined (or only with a certainty below a predetermined threshold).

Further, the processing unit 21 receives data from the graphical user interface 27 (e.g. inputs from the user).

The object recognition unit 22 performs an object recognition process (as also discussed above) for recognizing an individual fruit and for assigning the recognized individual fruit to a kind of fruit. The object recognition process as described herein will also be referred to as fruit recognition process. The fruit recognition process is based on image data which are transmitted to the object recognition unit 22 by the processing unit 21.

The object recognition unit 22 furthers transmit data to the processing unit 21, the degree of ripeness estimation unit 23 and to the harvest point of time determination unit 24.

The degree of ripeness estimation unit 23 performs a degree of ripeness estimation process. The degree of ripeness estimation process is based on image data, which are transmitted to the degree of ripeness estimation unit 23 by the processing unit 21.

The degree of ripeness estimation process is further based on data concerning the recognized individual fruit transmitted by the object recognition unit 22.

The degree of ripeness estimation unit 23 further transmits data concerning the estimated degree of ripeness to the processing unit 21 and to the harvest point of time determination unit 24.

The harvest point of time determination unit 24 performs a harvest point of time determination process. The harvest point of time determination process is based on data concerning the recognized individual fruit transmitted by the object recognition unit 22.

The harvest point of time determination process is further based on data concerning the estimated degree of ripeness transmitted by the degree of ripeness estimation unit 23.

The harvest point of time determination process is further based on environmental conditions, as described above. Data concerning environmental conditions are transmitted by the environmental condition determination unit 28.

The harvest point of time determination unit 24 further transmits data concerning the determined harvest point of time to the processing unit 21.

The display unit 25, which further includes a display screen, receives image data from the processing unit 21 and displays the acquired image.

The display unit 25 further receives image data from the graphical user interface 27.

The graphical user interface 27 receives data from the processing unit 21. The data include data concerning the recognized individual fruit, including the position of the recognized individual fruit and the kind of fruit the recognized individual fruit is assigned to, the estimated degree of ripeness of the recognized individual fruit, and the determined harvest point of time of the recognized individual fruit.

The graphical user interface 27 transmits image data to the display unit 25 in order to visualize the received data. In this example, the recognized individual fruit is highlighted on the acquired image as shown in FIG. 1. The degree of ripeness may be visualized by superimposing, on the screen of the display unit, a percentage indicating the degree of ripeness, or superimposing any other graphic indicating the degree of ripeness. The harvest point of time may be visualized by superimposing a harvesting date on the screen or superimposing any graphic indicating the harvest point of time.

The environmental condition determination unit 28 performs an environmental condition determination process, based on environmental data or information which is input by the user and/or received from the internet or over network or over an API to a weather application and the like. Moreover, environmental data is determined based on the image data (e.g. illumination data or the like), as will also be described further below.

The environmental condition determination unit 28 transmits data concerning environmental conditions to the harvest point of time determination unit.

The environmental condition determination unit 28 further receives image data from the processing unit 21.

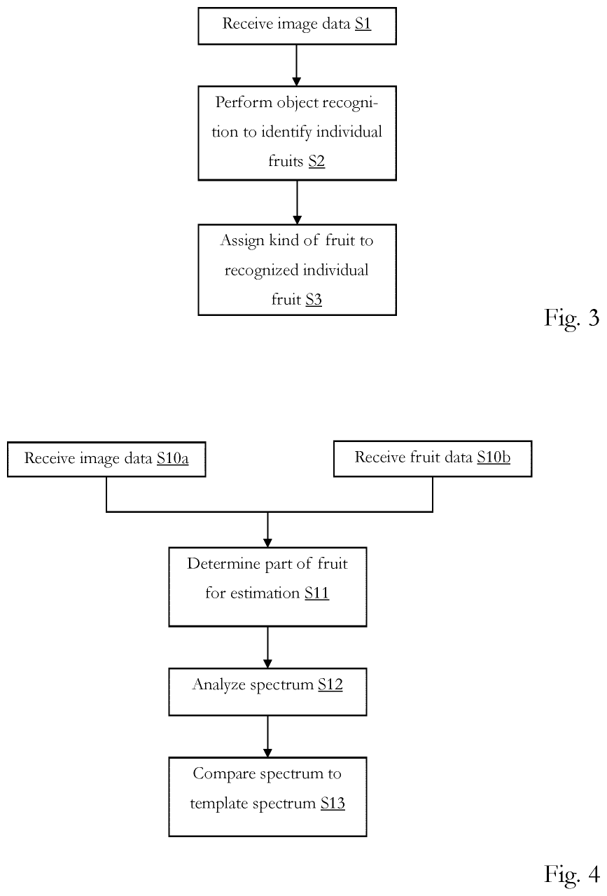

FIG. 3 shows the fruit recognition process as performed by the object recognition unit 22 of the mobile phone 10.

In S1, the object recognition unit 22 receives image data from the processing unit 21 (wherein the image data has been taken with the image acquisition unit 20).

In S2, object recognition is performed in order to recognize an individual fruit and especially to distinguish fruits from other parts of a plant.

In S3, a kind of fruit is assigned to the recognized individual fruit.

FIG. 4 shows the degree of ripeness estimation process as performed by the degree of ripeness estimation unit 23 of the mobile phone 10.

In S10a, image data from the processing unit 21 is received.

In S10b, fruit data from the object recognition unit 22 is received. Fruit data include the position of the recognized individual fruit within the image. Fruit data further include the kind of fruit of the recognized individual fruit.

The image data and the fruit data are used in combination in order to decide at which part of the image the estimation process is being performed. For example, it might be sufficient to estimate the degree of ripeness of only a small part of the recognized individual fruit or, for example only on one pixel, and extrapolate the estimated degree of ripeness for the whole fruit. This might be the case for fruits which have a uniform color as a tomato in its ripe state. On the other hand, it might be sufficient to estimate the degree of ripeness of every pixel of the position of the image at which the recognized individual fruit is positioned. This might be the case for fruits which do not have a uniform color as an apple. The determination which part of the recognized individual fruit is used for estimation happens in S11.

In S12, the spectral data of the part determined in S11 is analyzed.

In S13, the spectral data analyzed in S12 is compared to template spectra. The template spectra correspond to typical spectra of different degrees of ripeness of the kind of fruit to which the recognized individual fruit is assigned to.

The comparison includes determining to which of the template spectra the spectral data taken from the image data corresponds the most. The degree of ripeness of the recognized individual fruit then corresponds to the degree of ripeness of the most corresponding template spectrum.

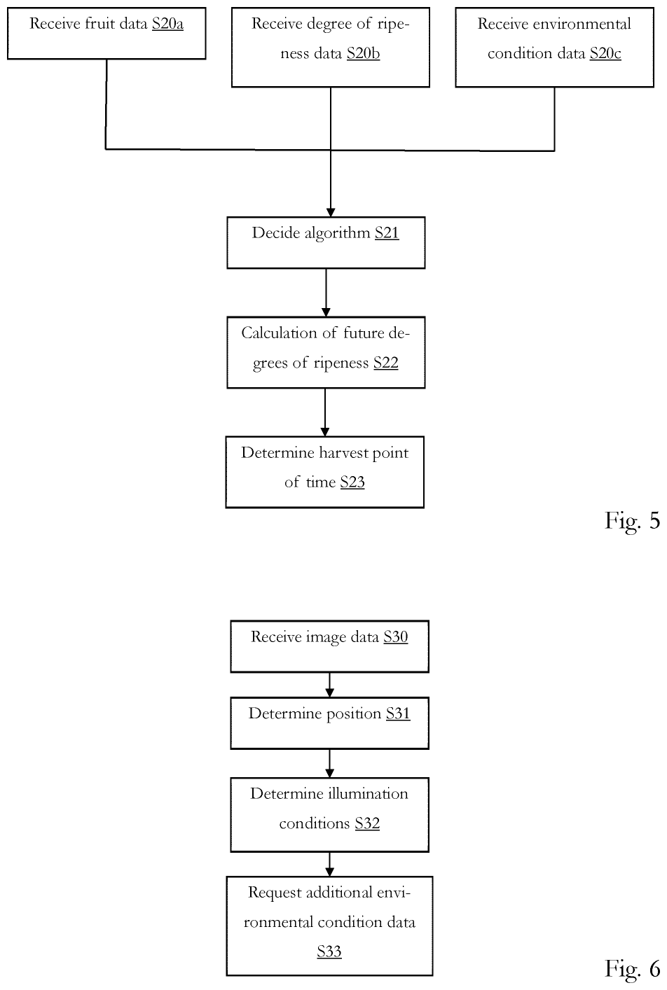

FIG. 5 shows the harvest point of time determination process as performed by the harvest point of time determination unit 24.

In S20a to S20c fruit data, degree of ripeness data, and environmental condition data are respectively received from the object recognition unit 22, the degree of ripeness estimation unit 23, and the environmental condition determination unit 28, respectively.

In S21, a ripening algorithm which is suitable for determining the harvest point of time of the specific kind of fruit, i.e. the ripening algorithm depends on the kind of fruit.

The algorithm uses fruit data, such as the degree of ripeness, and environmental conditions, and/or the position of the recognized individual fruit within the plant. For example, a fruit placed at the lower part of the plant might ripe for a longer time than a fruit positioned at the upper part of the plant since the fruit placed at the upper part of the plant may receive more irradiation. Further, the algorithm may take data from a weather forecast into account or any other environmental condition as described above. The algorithm may also take into account all of the above mentioned environmental conditions or a combination of a subset of the above mentioned environmental conditions, or none of them.

In S22, with the help of the algorithm, future degrees of ripeness are calculated.

In S23, a harvest point of time is determined based on a predetermined future degree of ripeness among the future degrees of ripeness calculated at S22. The predetermined future degree of ripeness may be 100%. It is also possible that the harvest point of time is determined based on a predetermined future degree of ripeness below or above 100%, depending on the kind of fruit or the user's preference.

FIG. 6 shows the environmental condition determination process as performed by the environmental condition determination unit.

In S30, image data from the processing unit 21 are received.

In S31, the position of the plant is determined based on image data.

In S32, illumination conditions are determined.

In S33, data concerning additional environmental conditions are requested, which are not determinable via image data. The request may be a request on a server or database storing data concerning additional environmental conditions or a request on different servers.

Additional environmental conditions are any environmental condition not determinable via image data, such as the determination whether the plant is placed inside or outside, if not determinable via image data.

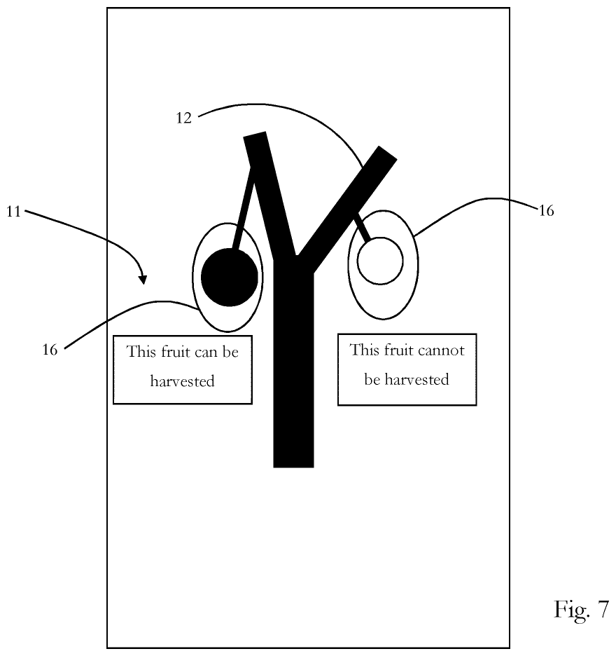

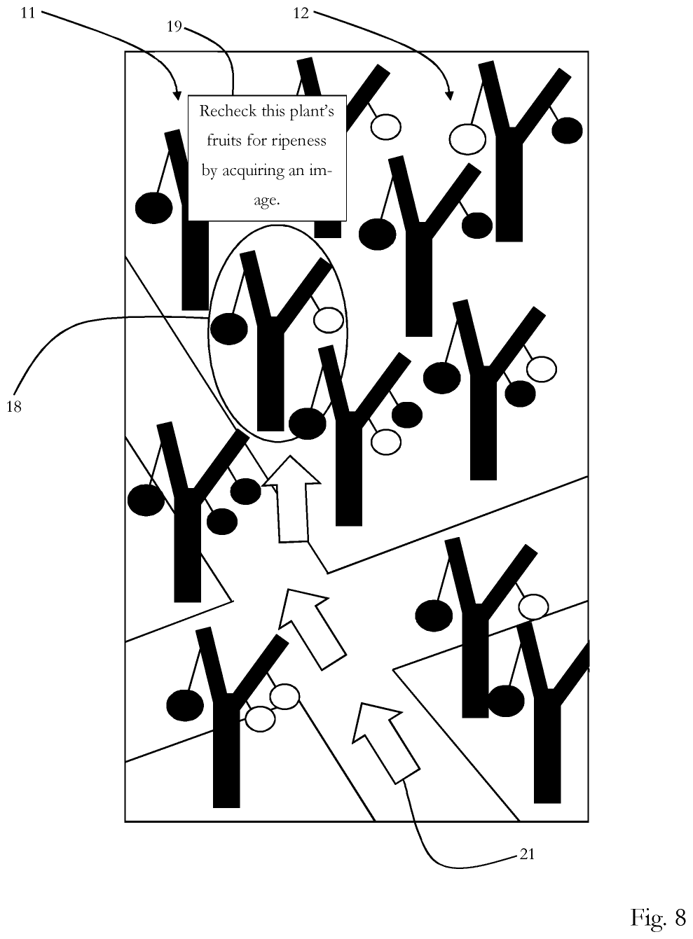

FIG. 7 shows an example of the graphical user interface 27. The graphical user interface 27 is configured to display text associated to each recognized individual fruit whether the fruit can be harvested or not, for example. The text “This fruit can be harvested” as associated to the ripe fruit 14 is displayed when the degree of ripeness estimation process of the recognized individual fruit estimates a value at least or above a predetermined threshold value. The text “This fruit cannot be harvested” as associated to the unripe fruit 15 is displayed when the degree of ripeness estimation process of the recognized individual fruit estimates a value below a predetermined threshold value.

FIG. 8 shows an example of how the graphical user interface may indicate the coarse position of the recognized individual fruit. It is displayed, on the display screen of the display unit 11, a plurality of plants 12 as they may be found in a garden or in a greenhouse, for example.

If further image data are to be acquired, for example when a previously determined point of time is reached, the position of the corresponding plant is highlighted, with an ellipse 18. It is also possible to highlight the corresponding plant in other ways, for example with a circle, a rectangle, or other geometrical figures, or highlighting it with a color, or the like.

A checkbox 19 is superposed on the graphical user interface indicating to recheck the highlighted plant's fruits for ripeness.

Further the position of the plant is indicated with arrows 21. Indicators may also be any other geometrical figure other than an arrow, for example straight lines.

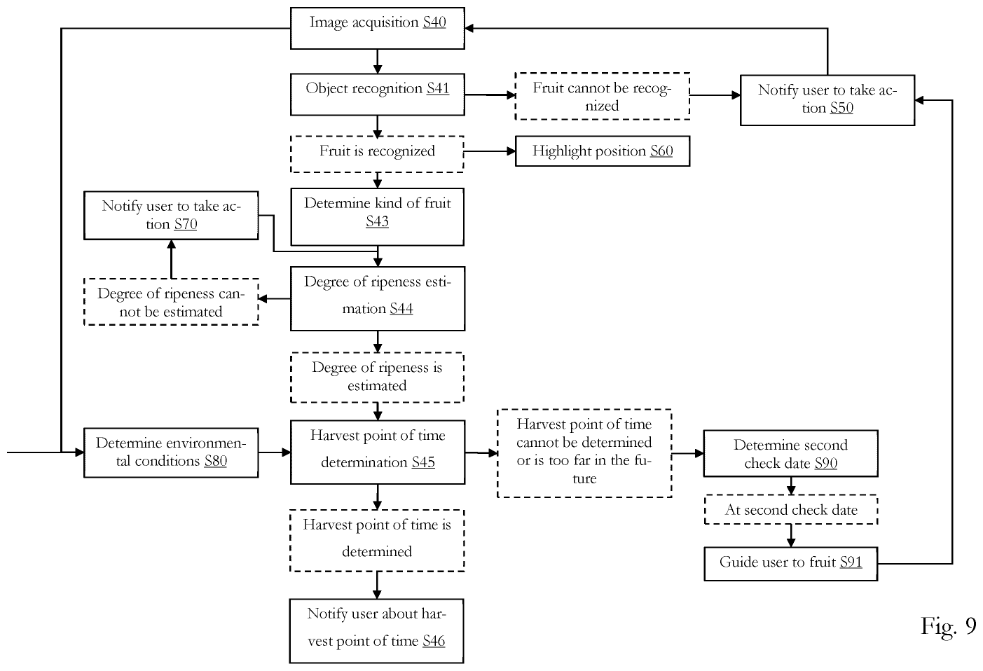

FIG. 9 shows a method performed by the information processing apparatus 10.

In S40, an image is acquired.

In S41, object recognition is performed. The object recognition is configured to recognize a fruit as described above with reference to FIG. 3.

If recognizing the fruit fails, it is required that the user takes an action, hence the user is notified to take an action (S50).

If at S43 the kind of fruit is determined, at S44 the degree of ripeness is estimated as described above with reference to FIG. 4.

If the degree of ripeness cannot be estimated (or only with a high uncertainty, i.e. a certainty below a given threshold), the user is notified to take action (S70). This is, for example, the case when the acquired image data is not sufficient for the degree of ripeness estimation process. In this case, the user is notified to acquire further image data.

In S45, after the degree of ripeness estimation process is performed, the harvest point of time is determined according to the harvest point of time determination process, which is described above with reference to FIG. 5, after environmental conditions are determined in S80 according to the environmental condition determination process, which is described above with reference to FIG. 6.

If the harvest point of time cannot be determined, a second check date is determined.

At the second check date, in S91, the user is guided to the recognized individual fruit as described above with reference to FIG. 8 and the user is notified to take action (S50), i.e. acquire further image data (S40).

At S46, after the harvest point of time is determined, the user is notified about the harvest point of time. If the degree of ripeness is above a predetermined threshold value at the time of performing the described method, the user is notified that the fruit can be harvested. If the degree of ripeness is below a predetermined threshold value at the time of performing the described method, the user is notified that the fruit cannot be harvested.

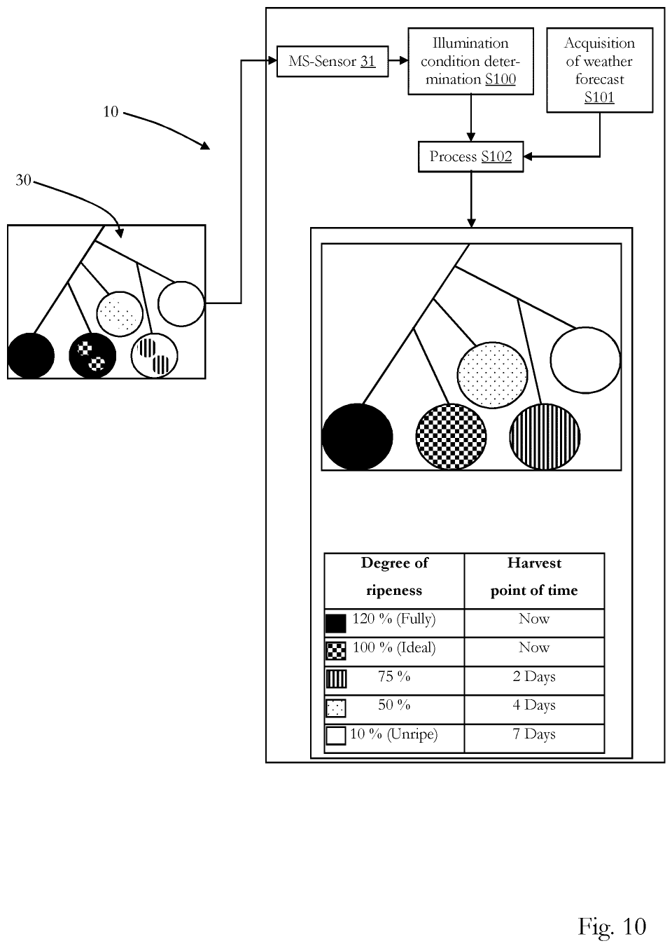

FIG. 10 is another illustration of the mobile phone 10, which is provided for enhancing the understanding of the present disclosure, wherein a multispectral sensor 31 is provided at the mobile phone 10, which may be, for example, connected to the mobile phone 10 over a universal serial bus interface.

First, an image of a plurality of fruits 30 is acquired with the multispectral sensor 31. With the help of the sensor data, illumination conditions are determined (S100).

Further, data of a weather forecast are acquired (S101).

Then, a process (S102) is performed. The process includes the object recognition process in order to recognize individual fruits, the degree of ripeness estimation process for each recognized individual fruit, and the harvest point of time determination process.

At the degree of ripeness estimation process, the multispectral image data serve as a basis for recognizing pigment concentrations in the recognized individual fruits which are indicated with patterns in FIG. 9. On the other hand, the pigment concentration is an indicator for the degree of ripeness.

On the basis of the pigments, the image of the recognized individual fruits displayed on the display screen of the display unit 11 is processed in a way that, for a user, the pigments are recognizable. This is represented in the displayed image by displaying the recognized individual fruit with a color which is indicative of the degree of ripeness of the recognized individual fruit (e.g. green for a tomato which has not yet reached a predetermined degree of ripeness).

Further, the harvest point of time is determined for each recognized individual fruit. The harvest point of time for each recognized individual fruit is displayed in a harvest schedule on the display screen. The harvest schedule includes the display of the estimated degree of ripeness for each recognized individual fruit and the harvest point of time.

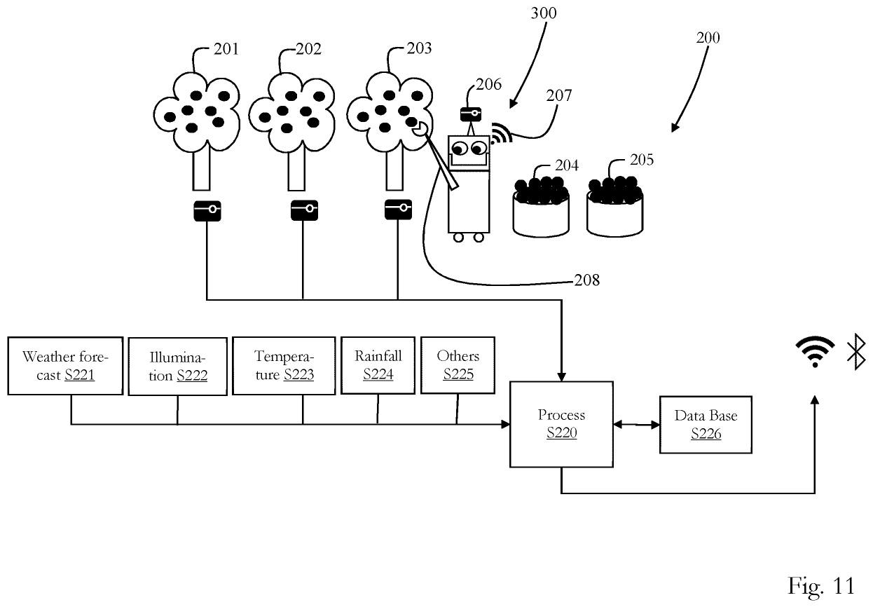

In the following, an embodiment of a system 200 for a harvesting robot 201 is explained under reference of FIG. 11.

The system 200 includes a harvest robot 300 for harvesting a plurality of trees 201, 202, 203 as they may be found in an orchard. In this embodiment, the trees are apple trees, without limiting the present disclosure in that respect. For example, also pear trees, cherry trees, tomato shrubs, or any other trees may be harvested. The system further includes two baskets 204 and 205 for collecting harvested fruits. In other embodiments, also only one basket, no basket at all, or any number above two baskets are provided. The system 200 is not limited to comprise baskets, also barrels, trailers, or anything able to contain fruits may be provided.

The harvest robot 300 has a multispectral camera 206, a Wi-Fi interface 207 and automated harvest scissors 208.

The harvest robot 300 uses the image data of the multispectral camera 206 in order to detect positions of apples on the trees 202 to 204. Then, the harvest robot 300 estimates a degree of ripeness of the recognized individual apples and estimates a quality status of the recognized individual apples. The quality status may depend on the color of a recognized individual apple, the time it already ripened, or the like.

The harvest robot 300 recognizes apples with an estimated degree of ripeness above a predefined threshold value, for example 100° %, and considers them as “on target” by the robotic system, i.e. harvests them within a predefined amount of time, for example immediately or in one hour, or the like.

Data of recognized apples with an estimated degree of ripeness below the predefined threshold value, in specific the estimated degree of ripeness and the position are stored in a data base S226, which is included in a centralized system also storing other data, such as market trends, weather conditions, or the like. In other embodiments the data base may be included in the harvest robot 300.

A process S220 determines a harvest point of time and for the determination of the harvest point of time, the multispectral image data is used. In addition, the process S220 uses data of a weather forecast S221, data including illumination conditions S222, temperature data S223, rainfall data S224, and other data S225 influencing the ripening process of apples.

The process S220 is performed in the circuitry within the harvest robot 300, but it may also be performed by circuitry outside of the harvest robot 300, wherein the harvest robot 300 is then configured to communicate with the circuitry outside of the harvest robot 300 via the Wi-Fi interface 207, via Bluetooth, or the like.

The “on target” status depends on the estimated degree of ripeness and/or of the estimated quality and on an external forecast, which includes weather forecast, or the like. The external forecast may further include market trends, time of the year, preferences of consumers, or the like.

The multispectral camera 206 is not limited to be mounted on the harvest robot 300. For example, the system may be applied in a greenhouse, wherein the greenhouse may be equipped with a plurality of multispectral cameras 206, wherein a harvest robot 300 may acquire multispectral image data via a communication with a centralized system connected to and controlling the multispectral cameras 206. In a greenhouse, depending on the multispectral image data, conditions for optimal ripening of the fruits may be automatically changed, such as illumination, temperature, humidity, or the like.

The harvest robot 300 may visualize, for a user, a harvesting table indicating which fruit at which tree may be harvested at which time, for example. The visualization may be realized on a display included in the harvest robot 300 on a display external of the harvest robot 300, wherein the harvest robot is then further configured to communicate with the display via an interface, for example Wi-Fi, Bluetooth, or the like.

The harvesting table is as follows in this embodiment:

| | | | | Harvest | | |
|---|---|---|---|---|---|---|
| Plant | Fruit | Position | Degree of | point of | Storage | |
| (Tree) | number | (cm) | ripeness (%) | time (Day) | time (Day) | Delivery Date |
| 1 | 1 | xyz | 120 | 0 | X | DD.MM.YYYY |
| 1 | 2 | xyz | 100 | 0 | X | DD.MM.YYYY |
| 2 | 1 | xyz | 75 | 2 | X | DD.MM.YYYY |
| 2 | 2 | xyz | 50 | 4 | X | DD.MM.YYYY |
| 3 | 1 | xyz | 10 | 7 | X | DD.MM.YYYY |

The first column refers to plants, wherein the plants correspond to the trees 201, 202, 203. The second column refers to fruit numbers, which are assigned to individual fruits of a plurality of fruits of an individual plant, e.g. the tree 201. The third column refers to a position of the individual fruits, namely as coordinates xyz of a relative coordinate system known to the harvest robot 300 (or provided by a centralized system). The fourth column refers to an estimated degree of ripeness for the associated fruit. The fifth column refers to a determined harvest point of time for the associated fruit. The sixth column refers to a storage time in the case of fruits ripening after they are harvested, for example bananas, or the like. The seventh column refers a delivery date, which is a date at which, for example, an order of a costumer who ordered a specific fruit or a certain amount of fruits, has to be carried out.

It should be recognized that the embodiments describe methods with an exemplary ordering of method steps. The specific ordering of method steps is however given for illustrative purposes only and should not be construed as binding. For example the ordering of S31, S32 and S33 in the embodiment of FIG. 6 may be exchanged. Also, the ordering of S40 and S80 in the embodiment of FIG. 9 may be exchanged. Other changes of the ordering of method steps may be apparent to the skilled person.

Please note that the division of the information processing apparatus 10 into units 21, 22, 23, 24, 28 is only made for illustration purposes and that the present disclosure is not limited to any specific division of functions in specific units. For instance, the information processing apparatus 10 could be implemented by a respective programmed processor, field programmable gate array (FPGA) and the like.

A method for controlling an electronic device, such as an information processing apparatus 10 discussed above, is described in the under reference of FIG. 9. The method can also be implemented as a computer program causing a computer and/or a processor, such as processor unit 21 discussed above, to perform the method, when being carried out on the computer and/or processor. In some embodiments, also a non-transitory computer-readable recording medium is provided that stores therein a computer program product, which, when executed by a processor, such as the processor described above, causes the method described to be performed.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.
(1) An information processing apparatus, comprising a circuitry configured to: perform object recognition for recognizing an individual fruit based on image data; and determine a harvest point of time for the recognized individual fruit.
(2) The information processing apparatus of (1), wherein the circuitry is further configured to estimate a degree of ripeness of the recognized individual fruit, wherein the harvest point of time is determined based on the estimated degree of ripeness of the recognized individual fruit.
(3) The information processing apparatus of (1) to (2), wherein the estimation of the degree of ripeness of the recognized individual fruit is based on multispectral image data.
(4) The information processing apparatus of (1), wherein performing the object recognition includes determining a kind of fruit for the recognized individual fruit.
(5) The information processing apparatus of anyone of (1) to (4), wherein the determination of the harvest point of time for the recognized individual fruit is based on the kind of fruit.
(6) The information processing apparatus of anyone of (1) to (5), wherein the determination of the harvest point of time is based on at least one environmental condition.
(7) The information processing apparatus of (6), wherein the at least one environmental condition includes at least one of: meteorological information, geographical position, illumination conditions and architectural information.
(8) The information processing apparatus of anyone of (1) to (7), wherein the object recognition includes determining a position of the recognized individual fruit.
(9) The information processing apparatus of anyone of (1) to (8), wherein the circuitry is further configured to provide a graphical user interface for guiding a user to the recognized individual fruit.
(10) The information processing apparatus of anyone of (1) to (9), wherein the circuitry is further configured to provide a graphical user interface for guiding a user to acquire at least one of the image data and multispectral image data of the recognized individual fruit.
(11) A method for performing object recognition for recognizing an individual fruit based on image data; and determining a harvest point of time for the recognized individual fruit.
(12) The method of (11), further comprising estimating a degree of ripeness of the recognized individual fruit, wherein the harvest point of time is determined based on the estimated degree of ripeness of the recognized individual fruit.
(13) The method of anyone of (11) to (12), wherein the estimation of the degree of ripeness of the recognized individual fruit is based on multispectral image data.
(14) The method of anyone of (11), wherein performing the object recognition includes determining a kind of fruit for the recognized individual fruit.
(15) The method of anyone of (11) to (14), wherein the determination of the harvest point of time for the recognized individual fruit is based on the kind of fruit.
(16) The method of anyone of (11) to (15), wherein the determination of the harvest point of time is based on at least one environmental condition.
(17) The method of anyone of (16), wherein the at least one environmental condition includes at least one of: meteorological information, geographical position, illumination conditions and architectural information.
(18) The method of anyone of (11) to (17), wherein the object recognition includes determining a position of the recognized individual fruit.
(19) The method of anyone of (11) to (18) further comprising providing a graphical user interface for guiding a user to the recognized individual fruit.
(20) The method of anyone of (11) to (19) further comprising providing a graphical user interface for guiding a user to acquire at least one of the image data and multispectral image data of the recognized individual fruit.
(21) The method of anyone of (12) to (20), further comprising providing a graphical user interface for guiding a user to harvest the individual fruit based on the estimated degree of ripeness.
(22) A computer program comprising program code causing a computer to perform the method according to anyone of (11) to (21), when being carried out on a computer.
(23) A non-transitory computer-readable recording medium that stores therein a computer prom gram product, which, when executed by a processor, causes the method according to anyone of (11) to (21) to be performed.

1. An information processing apparatus, comprising circuitry configured to:
perform object recognition for recognizing an individual fruit based on image data; and
determine a harvest point of time for the recognized individual fruit.

2. The information processing apparatus of claim 1, wherein the circuitry is further configured to estimate a degree of ripeness of the recognized individual fruit, wherein the harvest point of time is determined based on the estimated degree of ripeness of the recognized individual fruit.

3. The information processing apparatus of claim 2, wherein the estimation of the degree of ripeness of the recognized individual fruit is based on multispectral image data.

4. The information processing apparatus of claim 1, wherein performing the object recognition includes determining a kind of fruit for the recognized individual fruit.

5. The information processing apparatus of claim 4, wherein the determination of the harvest point of time for the recognized individual fruit is based on the kind of fruit.

6. The information processing apparatus of claim 1, wherein the determination of the harvest point of time is based on at least one environmental condition.

7. The information processing apparatus of claim 6, wherein the at least one environmental condition includes at least one of: meteorological information, geographical position, illumination conditions and architectural information.

8. The information processing apparatus of claim 1, wherein the object recognition includes determining a position of the recognized individual fruit.

9. The information processing apparatus of claim 1, wherein the circuitry is further configured to provide a graphical user interface for guiding a user to the recognized individual fruit.

10. The information processing apparatus of claim 1, wherein the circuitry is further configured to provide a graphical user interface for guiding a user to acquire at least one of the image data and multispectral image data of the recognized individual fruit.

11. A method, comprising:
performing object recognition for recognizing an individual fruit based on image data; and
determining a harvest point of time for the recognized individual fruit.

12. The method of claim 11, further comprising estimating a degree of ripeness of the recognized individual fruit, wherein the harvest point of time is determined based on the estimated degree of ripeness of the recognized individual fruit.

13. The method of claim 12, wherein the estimation of the degree of ripeness of the recognized individual fruit is based on multispectral image data.

14. The method of claim 11, wherein performing the object recognition includes determining a kind of fruit for the recognized individual fruit.

15. The method of claim 14, wherein the determination of the harvest point of time for the recognized individual fruit is based on the kind of fruit.

16. The method of claim 11, wherein the determination of the harvest point of time is based on at least one environmental condition.

17. The method of claim 16, wherein the at least one environmental condition includes at least one of: meteorological information, geographical position, illumination conditions and architectural information.

18. The method of claim 11, wherein the object recognition includes determining a position of the recognized individual fruit.

19. The method of claim 11, further comprising providing a graphical user interface for guiding a user to the recognized individual fruit.

20. The method of claim 11, further comprising providing a graphical user interface for guiding a user to acquire at least one of the image data and multispectral image data of the recognized individual fruit.

21. The method of claim 12, further comprising providing a graphical user interface for guiding a user to harvest the individual fruit based on the estimated degree of ripeness.
